(19) United States
(12) Patent Application Publication
(10) Pub. No.: US 2017/0154159 A1
(43) Pub. Date: Jun. 1, 2017

(54) SYNCHRONIZED MULTIMEDIA SYSTEM FOR THERAPY RECORDING, PLAYBACK, ANNOTATION AND QUERY IN BIG DATA ENVIRONMENT

(71) Applicant: Umm Al-Qura University, MAKKAH (SA)

(72) Inventor: Mohamed Abdur Rahman, Makkah (SA)

(21) Appl. No.: 14/953,338

(22) Filed: Nov. 28, 2015

(51) Int. Cl. G06F 19/00; A63F 13/87; H04N 5/91; G11B 27/10; G06T 19/00

(52) U.S. Cl. CPC G06F 19/3418; G11B 27/10; G06T 19/006; H04N 5/91; A63F 13/87; G06F 19/321

(57) ABSTRACT

There is provided a multimedia system and method for use in at-home therapy. The multimedia system synchronizes data such as audio and video data with skeletal data of a patient. The system allows for a therapist to fully monitor, evaluate, advise and interact with a patient performing therapeutic physical activities at home.

### FIELD OF TECHNOLOGY

This disclosure relates generally to multimedia systems for use in at-home therapy. More specifically, this disclosure relates to a multimedia system that synchronizes data such as audio and video data with skeletal data of a patient. The system allows for a therapist to fully monitor, evaluate, advise and interact with a patient performing therapeutic physical activities at home.

### BACKGROUND

At-home therapy is becoming increasingly popular, particularly as the population ages. Also, at-home therapy may be important for populations living in remote areas with limited access to a therapist. Systems for connecting therapists and patients are known in the art; however, such system does not always allow for a full interaction between the two groups. For example, such system may not allow for a therapist to visualize and monitor how the patient performs therapeutic physical activities prescribed by the therapist. This limitation is caused by the fact that synchronization of multimedia data such as audio and video with the skeletal data of a patient is a challenging task. Indeed, the media characteristics of video and audio are different from skeletal stream data.

There is a need for more efficient systems for use in at-home therapy that involves a patient performing physical activities.

### SUMMARY

The present disclosure relates to a multimedia system that synchronizes data such as audio and video data with skeletal joint data of a patient. Users of the system are both the therapist and the patient undergoing therapy at home. The system is a two-tier synchronization system. Firstly, all media are synchronized with respect to a global timestamp, which represents the user session. Secondly, the media streams are synchronized with respect to a model therapy skeletal stream to make semantic annotation or marker on top of the media streams. The two-tier synchronized multimedia streams represent the patient's at-home therapy session that may be saved in a big data repository for further analysis.

The big data repository uses map reduced functions to extract key quality of improvement metrics from the user session such that a patient may successfully follow the therapist instruction. The therapist may be able to monitor and assess how much of user session was done correctly, how many gestures were done incorrectly, etc.

A therapy recorder associated with the multimedia system of this disclosure may perform the two-tier synchronization process and create the synchronized multimedia therapy session file.

A therapy player associated with the multimedia system of this disclosure may unpack the complex session file and separate the media while keeping the synchronization of the media.

A therapist may use the therapy player to observe the user session, navigate the synchronized media and add his/her comments in the form of audio notes, video notes or text notes on any particular time frame of the user session. The annotation is embedded to the user session file using an annotation engine associated with the multimedia system of this disclosure. The annotations are also synchronized with the existing media streams.

A patient may observe the annotations made by the therapist using the playback mode of the player, and see multimedia notes to improve future sessions.

The query interface of the multimedia system of this disclosure is packed with features to see the statistics or graph plots of any individual session of a patient or a summary of historical session data of a patient. The features may also show complex relative statistics among a patient group.

Several embodiments for the multimedia system of the invention are outlined below.

This disclosure provides, according to an aspect, for a method, comprising: creating a media stream comprising audio and video data; creating a model skeletal data stream; synchronizing the media stream with the model skeletal data stream to create a synchronized multimedia stream; and storing the synchronized multimedia stream in a big data repository, wherein a user accesses the repository and performs physical activities based on the model skeletal data stream and records the physical activities, and wherein the user or at least one other user accesses the repository, evaluates the recorded physical activities and makes multimedia notes on the media stream, the notes being stored in a metadata file.

In one embodiment, the method further comprises synchronizing the multimedia notes with the synchronized multimedia stream and storing the synchronized multimedia stream and notes in the data repository.

In one embodiment, the notes are in a form selected from the group consisting of audio notes, video notes and text notes.

In one embodiment, the data repository further comprises data selected from the group consisting of statistical data, graphical data, summary of the physical activities for the user, historical data on the physical activities of the user, personal information of the user including name, date of birth, and banking information.

In one embodiment, the user or the at least one other user provides confidential identification codes prior to accessing the data repository.

In one embodiment, the user or the at least one other user performs a search in the metadata file.

In one embodiment, the user or the at least one other user makes queries from a query vocabulary database.

In one embodiment, the user reviews notes made by the at least other user and further performs and records revised physical activities based on the notes.

In one embodiment, the user or the at least one other user performs a business transaction including payment of a fee.

In one embodiment, the user is a patient, the at least one other user is a therapist, and the physical activities are therapeutic physical activities.

In one embodiment, the model skeletal data stream comprises a model therapy Avatar in the form of skeletal figure, an Avatar within a game environment or a skeleton projected on the raw video in an augmented reality environment.

According to another aspect, this disclosure provides for a multimedia system, comprising: a synchronized multimedia stream comprising a media stream including audio and video data, and a model skeletal data stream, the synchronized multimedia stream being stored in a data repository; a recorder for recording physical activities performed by a user based on the model skeletal data stream; and a player for outputting the recorded physical activities and for allowing production, by the user or the at least one other user, of multimedia notes on the media stream, the notes being stored in a metadata file.

In one embodiment, the recorder comprises at least one sensor selected from the group consisting of Kinect, LEAP, MYO and health sensors including heart rate monitor and pulse oximeter.

In one embodiment, the recorder comprises a gesture parser.

In one embodiment, the system further comprises a query analytics engine for performing searches in the metadata file.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 High-level architecture of an embodiment of the multimedia system of this disclosure.

FIG. 2 Design of a therapy recorder embodied in the multimedia system of the invention.

FIG. 3 The therapy player in visualization mode.

FIG. 4 The therapy player in annotation mode.

FIG. 5 Therapy query components of the multimedia system of the invention by which quality of improvement of a patient and detailed session statistics of historical session data may be inquired.

FIG. 6 Patient sequence diagram.

FIG. 7 Therapist sequence diagram.

FIG. 8 User interface for the session annotation tool.

FIG. 9 User interface for the session playback tool.

FIG. 10 User interface for the session recording tool.

Other features of the present embodiments will be apparent from the accompanying drawings and from the detailed description that follows.

### DETAILED DESCRIPTION

In order to provide a clear and consistent understanding of the terms used in the present disclosure, a number of definitions are provided below. Moreover, unless defined otherwise, all technical and scientific terms as used herein have the same meaning as commonly understood to one of ordinary skill in the art to which this disclosure pertains.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The present disclosure relates to a multimedia system that synchronizes data such as audio and video data with skeletal joint data of a patient. Users of the system are both the therapist and the patient undergoing therapy at home. The system is a two-tier synchronization system. Firstly, all media are synchronized with respect to a global timestamp, which represents the user session. Secondly, the media streams are synchronized with respect to a model therapy skeletal stream to make semantic annotation or marker on top of the media streams. The two-tier synchronized multimedia streams represent the patient's at-home therapy session that may be saved in a big data repository for further analysis.

### How the Multimedia System Works

The system is based on client server architecture. The patient may install on her PC, smartphone and/or tablet a sensory device such as a Kinect device, a LEAP device and a MYO device as well as any associated and necessary software platform. The therapist may suggest certain physical exercises to the patient which she may perform at home. The Kinect, LEAP and MYO devices connected to the patient's PC, smartphone or tablet may track joint movements and record video while the patient performs the exercise within the field of view of these sensory devices in front of it. The software platform uploads the therapy session to the big data server and informs the therapist. A server-based computational intelligence engine parses the joint data and detects the presence of different gestures that are part of the prescribed exercise. It also creates a metadata file to mark different events happening in the video with timestamps. Examples of such events are the start and stop of each repetition, the maximum and minimum angle of the joint in question and fixed data such as the name and type of the exercise and joint involved.

The therapist will be provided with a timeline-based interface through which he may look at the video and annotate the different areas of the video with text, audio, graphics and other forms of multimedia data. All the annotations will be stored in the metadata file. The tool will also allow the therapist to query the metadata file and look for frames with particular features. A user interface will allow the user to define criteria for search. The search will be performed in the metadata file, and related frames from the video will be pulled and displayed along with synchronized multimedia data.

### Architecture of the Multimedia System

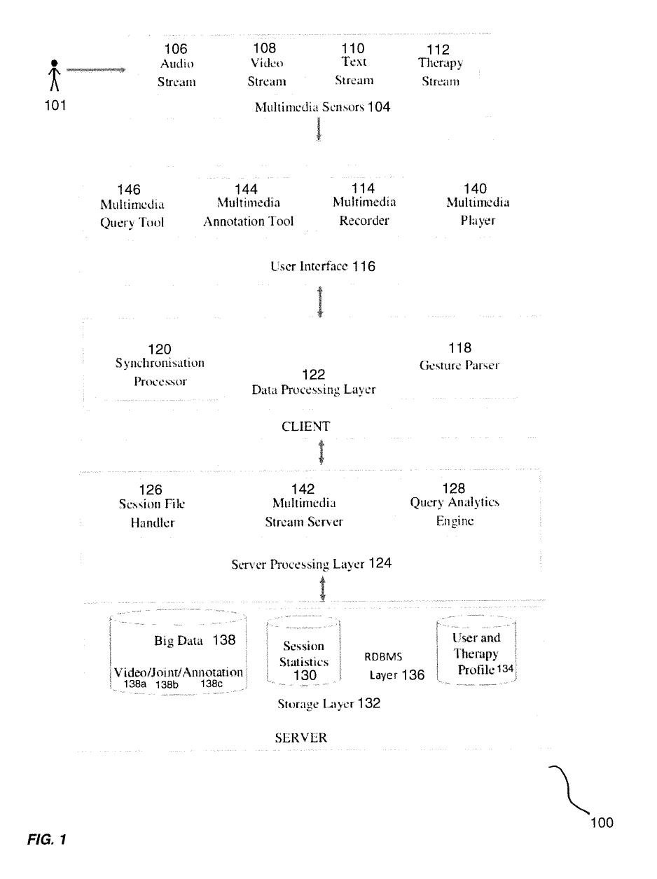

FIG. 1 depicts the high level architecture for an embodiment of the multimedia system 100 of this disclosure. The system accommodates two types of user 101, patient and therapist. In case of the patient, the user 101 has access to a variety of multimedia sensors 104 that are used to record therapeutic activities. The multimedia sensors 104 generate data streams including audio stream 106, video stream 108, text stream 110, and skeletal data stream 112.

When the user 101 chooses to perform a therapeutic activity, the various types of multimedia data streams (106, 108, 110, 112) from the sensors 104 are recorded by the multimedia recorder 114 in the client user interface 116. Gestures from the different streams of data (106, 108, 110, 112) are detected by the gesture parser 118 and these streams are collectively synchronized by the synchronization processor 120 at the data processing 122 layer. The result is a compact session file that is then sent to the data processing layer 122 at the server side where the session file handler 126 parses this session file to separate its different components. The query analytics engine 128 performs various types of analyses on these components and stores the results in the session statistics 130 at the storage layer 132. The user profile (patient information) and therapy profile (model exercise and the assigned therapies by the therapist) data is stored in the user and therapy profile 134 section of the relational database management system (RDBMS) 136. The raw session data is stored in the big data 138 architecture, which includes video/audio data 138a, skeletal joint data 138b, and annotation data 138c.

The second type of user may either be the patient or the therapist. This user may access various tools from the user interface 116 layer which provide different functionalities for playback and annotation of the recorded data. The multimedia player 140 allows the user 101 (patient or therapist) to playback and annotate a session. The multimedia player 140 may also display the session statistics on the screen. The video is pulled from the storage layer 132 and streamed by the multimedia stream server 142. The multimedia annotation tool 144 provides the user with an interface to make an audio-, video- or text-based annotation in the session video. The multimedia query tool 146 allows the user 101 to make various rich queries and analytics on all the data accessible to that user (for example, all patients under a therapist).

### Design of the Tools—the Therapy Recorder

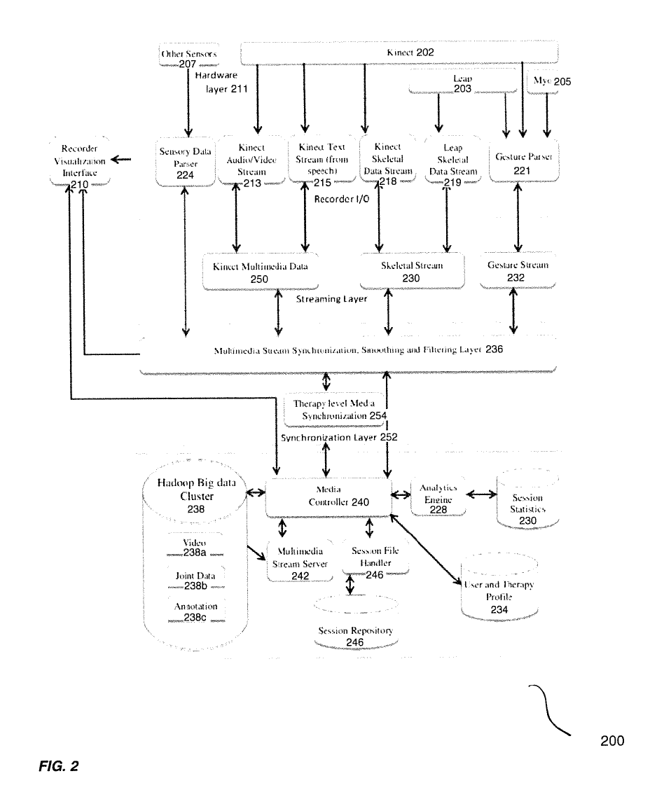

FIG. 2 depicts the internal details of the therapy recorder 200 of the multimedia system of this disclosure. The hardware layer 211 consists of the multimedia sensors like Kinect 202, LEAP 203, MYO 205 and other proprietary health sensors 207 (heart rate monitor, digital sphygmomanometer, etc.). Data from these sensors are received at the recorder Input/Output (I/O) 209 from where it is visualized on the recorder visualization interface 210. The various components in the recorder I/O 209 deliver different types of data received from the sensors at the hardware layer 211.

For example, the audio and video footage of the user (101, FIG. 1) from the Kinect sensor 202 is received by the Kinect Audio/Video stream 213 while any speech by the user (detected by Kinect) during the recording process is converted into a text stream by the Kinect text stream 215 component. The raw skeletal joint data of the patient is collected by the Kinect skeletal data stream 218 component while the user is performing exercises.

Similarly, the raw skeletal data of the patient's hand for example is sent to the LEAP skeletal data stream 219 component by the LEAP sensor 203. The gesture parser 221 detects various gestures from all the sensors 202, 203, 205 connected to it, e.g., Kinect, LEAP and MYO. Data from the other sensors 207 such as heart rate monitor, pulse oximeter etc. . . . is parsed by the sensory data parser 224. Data from these components along with the user and exercise data extracted from the user and therapy profile 234 repository (in the server layer 242) is displayed on the recorder visualization interface 210.

The streaming layer 248 in the recorder 200 is responsible for organizing and managing the various data streams received from the recorder I/O 209. Kinect multimedia data 250 contains the Kinect Audio/Video stream 213 and Kinect text stream 215 while the skeletal stream 230 receives the Kinect skeletal data stream 218 and LEAP skeletal data stream 219. The gesture parser 221 passes on the various gestures to the gesture stream 232 component which organizes the gesture streams from the three devices' sensors 202, 203, 205. These distinct streams from the streaming layer 248 are then collectively organized into a compact session file at the synchronization layer 252.

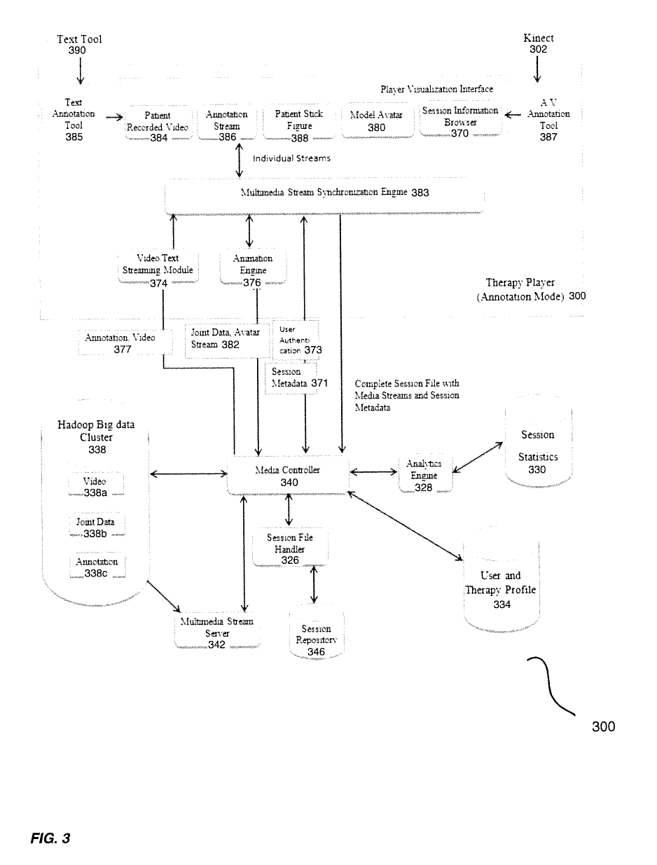

The multimedia stream synchronization, smoothing and filtering layer 236 synchronizes the different data streams (gesture, skeletal and multimedia) and also performs some smoothing and filtering operations on the raw data. The therapy level media synchronization 254 component observes gestures from the data stream and the model Avatar (380, FIG. 3) to determine the start and end point of performed gestures. The session file produced at the streaming layer 248 is then sent to the server layer 242. The media controller 240 maintains the flow of data at the server side. The session file is parsed by the session file handler 226 where the raw data (video of the session, skeletal joint data and annotations made on the video) is separated and stored in the Hadoop big data cluster 238 whereas the session metadata is stored in the session repository 246. The session metadata is sent to the analytics engine 228 which performs various analyses on the data to separate the statistical data which is stored in the session statistics 230. The Hadoop big data cluster 238 comprises video/audio data 238a, skeletal joint data 238b, and annotation data 238c.

### Design of the Tools—the Therapy Player

FIG. 3 shows the details of the therapy player in the visualization mode 300. When user (101, FIG. 1) logs into the system, user authentication 373 is performed by fetching the information from the user and therapy profile 334 repository. Corresponding to the logged-in user, all the session metadata 371 (using information from user profile) is brought from the session repository 346 and displayed in the session information browser 370 component in the player visualization interface 372. From a list of displayed sessions, user then selects one of them for review.

The information for this session is then retrieved from the session repository 346 and passed on to the session file handler 326. Based on the parsed information from the session file handler 326, the media controller 340 then retrieves the required information from the storage. The annotation data 338c and skeletal joint data 338b are brought in from the Hadoop big data cluster 338. The model therapy Avatar for the exercise is fetched from the user and therapy profile 334 repository and statistical data from session statistics 330. The annotation data 338c and the video 377 from the multimedia stream server 342 are streamed to the Video/Text streaming module 374 whereas the skeletal joint data and model Avatar data 382 are streamed to the animation engine 376 (an animation framework for visualizing the raw skeletal joint data and model therapy data as figures and Avatars) in the therapy player. The synchronized stream player 383 receives the annotated video stream, animated figure streams and session statistical and metadata and displays them accordingly in their corresponding placeholders in the player visualization interface 372. The patient recorded video 384 component displays the recorded video of the therapy session performed by the patient. Annotation stream 386 represents the different types of previously annotated data (such as text 385, audio and video annotation 387). patient stick FIG. 388 component displays the animated skeletal joint data stream of the patient performing the exercise, and model Avatar 380 displays the ideal animated therapy model Avatar which the patient is supposed to emulate. All the other user- and session-related information is displayed on the session information browser 370.

### Design of the Tools—the Annotation Tool

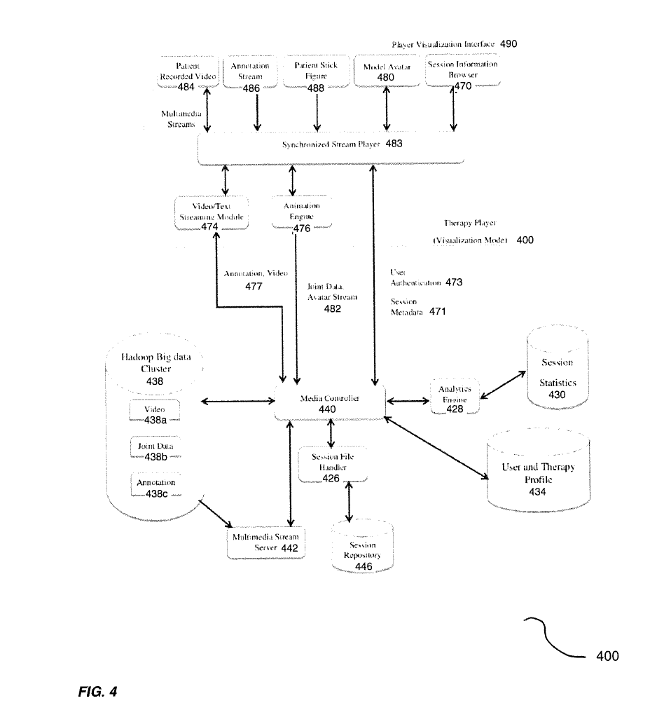

FIG. 4 depicts the internal details of the therapy player in annotation mode 400. This mode is similar to the visualization mode depicted in FIG. 3, in the sense that the process of retrieving and playing multimedia is identical. In addition to the features offered in the visualization mode, the annotation mode allows the user (101, FIG. 1) to make annotations at any point in the video. For this purpose two hardware components are used: the text tool (390, FIG. 3) and the Kinect sensor (202, FIG. 2). If the user wants to add text annotation to any point in the video, then she uses the text tool, the input of which is received by the text annotation tool (387, FIG. 3) of the therapy player. If the user wants to add audio or video annotation, then she uses the Kinect sensor video camera which sends the annotations to the A/V annotation tool (Audio/Video). These annotations are displayed by the player visualization interface 490 along with the session information pulled from the storage. The annotations are then sent to the multimedia stream synchronization engine 483 so that they may be synchronized with the previous data. This component produces the final session file with the annotated media streams and the session metadata 471 which is then sent to the media controller 440 on the server side. The media controller 440 hands the file over to the session file handler 426 which parses the file and separates the different parts, to be stored accordingly as previously explained. The video/audio data 438a and annotated data 438c are kept separately in the Hadoop big data cluster 438.

### Design of the Tools—the Query Tool

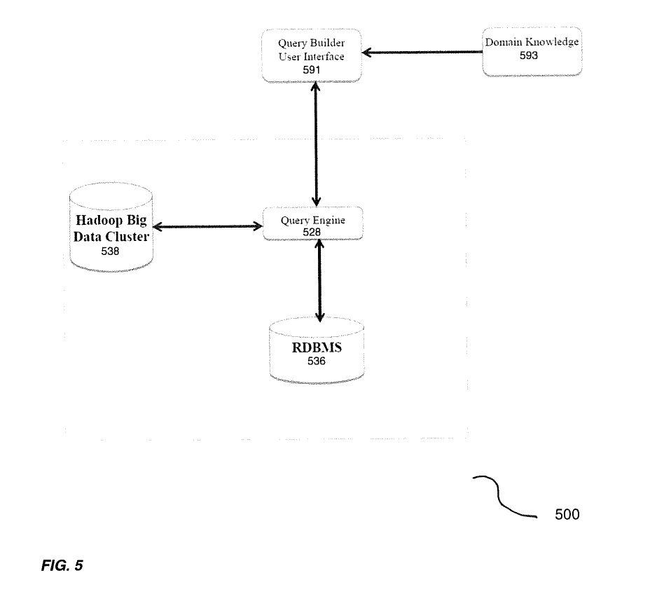

FIG. 5 depicts the therapy query components of the multimedia system of this disclosure. The query tool 500 comprises of a query builder user interface 591 that helps a user (101, FIG. 1), patients and therapists in writing queries from a query vocabulary using domain knowledge 593. The queries are handled by a query engine 528, which sends query to both relational database management systems 536 and Hadoop big data cluster 538 where session files such as audio, video, skeletal joint data, annotation data are stored. The query results are reflected to the query builder user interface at the end.

### Sequence Diagrams

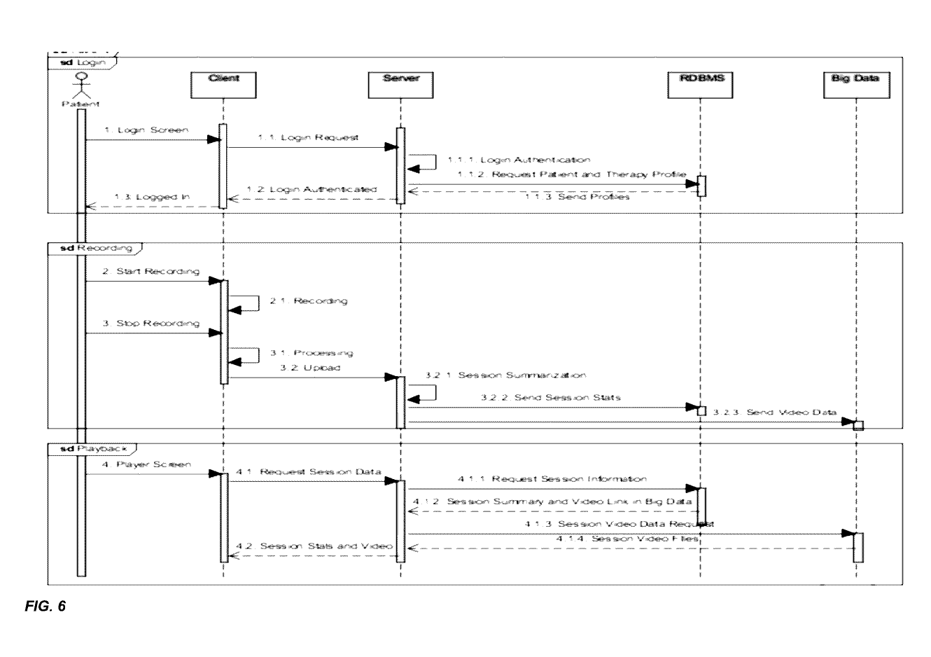

FIG. 6 shows the interaction of a patient with the system. The patient may perform three types of activities; login, record and playback. To use the system, the patient has to login first. Once the patient is logged in, his profile is pulled from the database which contains his basic information as well as the exercise he is prescribed. Details of the exercise are also pulled from the database. To start recording, the patient selects the option from the screen. When the recording is stopped, a script on the client processes it and uploads it to the server. Another script on the server processes the data and prepares a session summary that contains minimum, maximum and average values of different metrics extracted from the gestures preformed in the exercise. The session statistics are stored in the database while the session video files are stored in the big data repository. For playback, the user requests a particular session. The session data is retrieved from the RDBMS which also provides link to the big data repository for locating the video files. This information is sent to the big data server which responds by sending the appropriate video files.

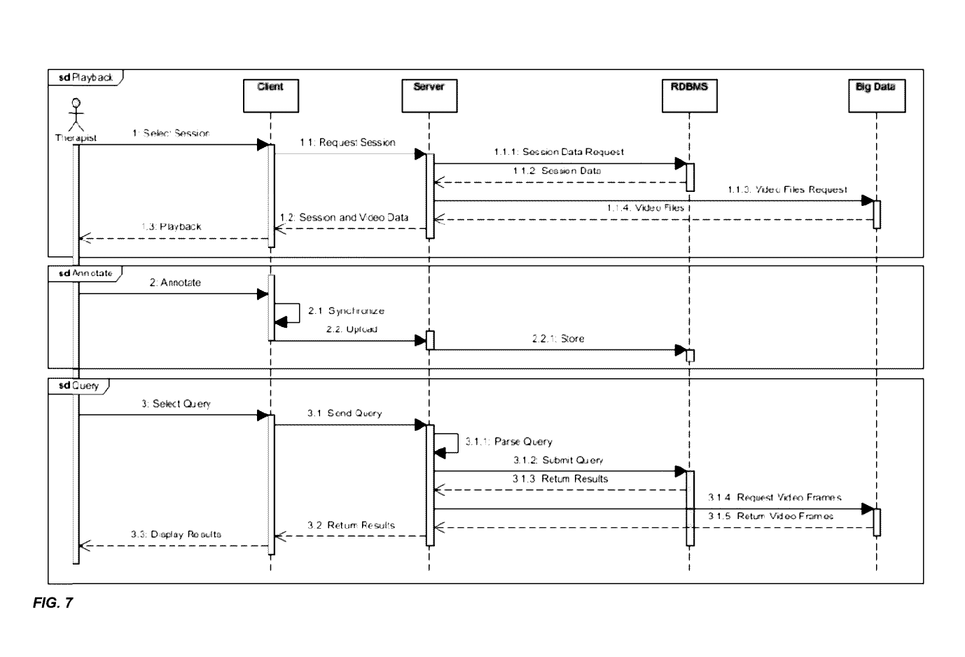

The therapist is given the facility of viewing, annotating and querying exercise sessions based on different metrics; see FIG. 7. The playback component works in the same manner as described above. During playback, the therapist may annotate a session. The annotation is synchronized with the rest of the data and uploaded to the server where it is stored in the RDBMS. For querying exercise sessions, the therapist is given a screen where he may submit queries based on different metrics. The query is performed on the RDBMS and the results are returned to the therapist. The related video frames are pulled up from the big data repository and displayed on the therapist's screen.

### User Interface

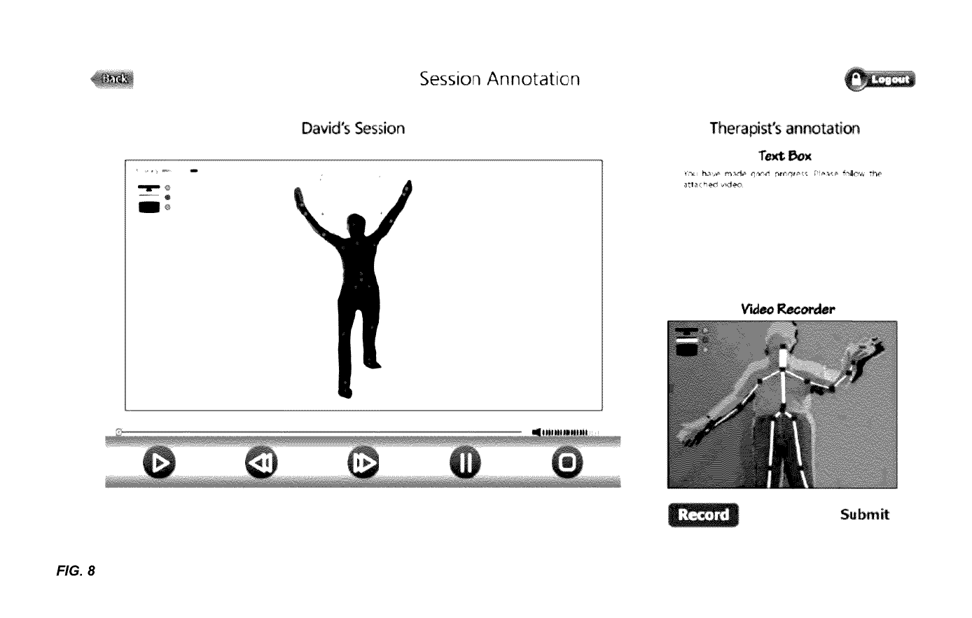

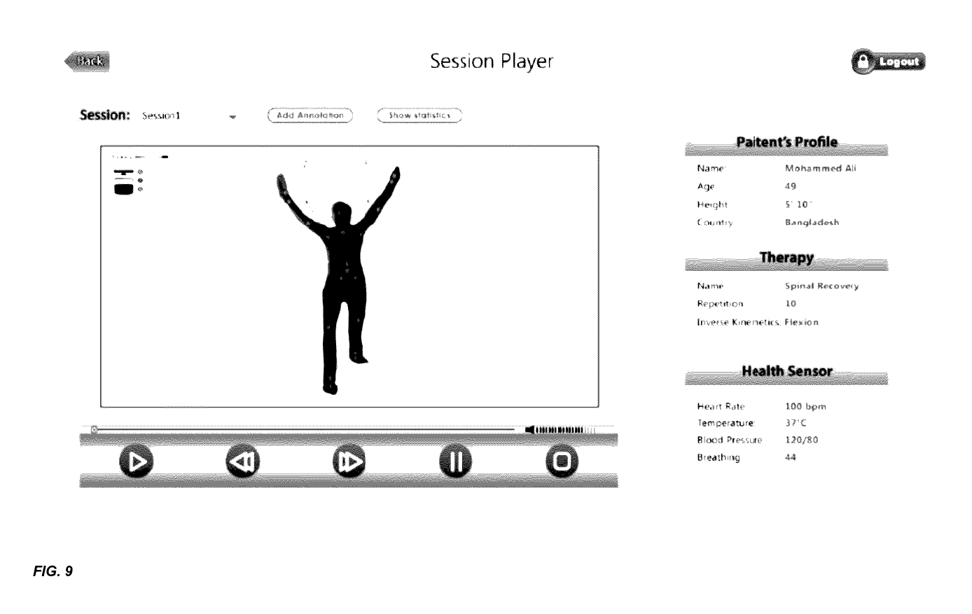

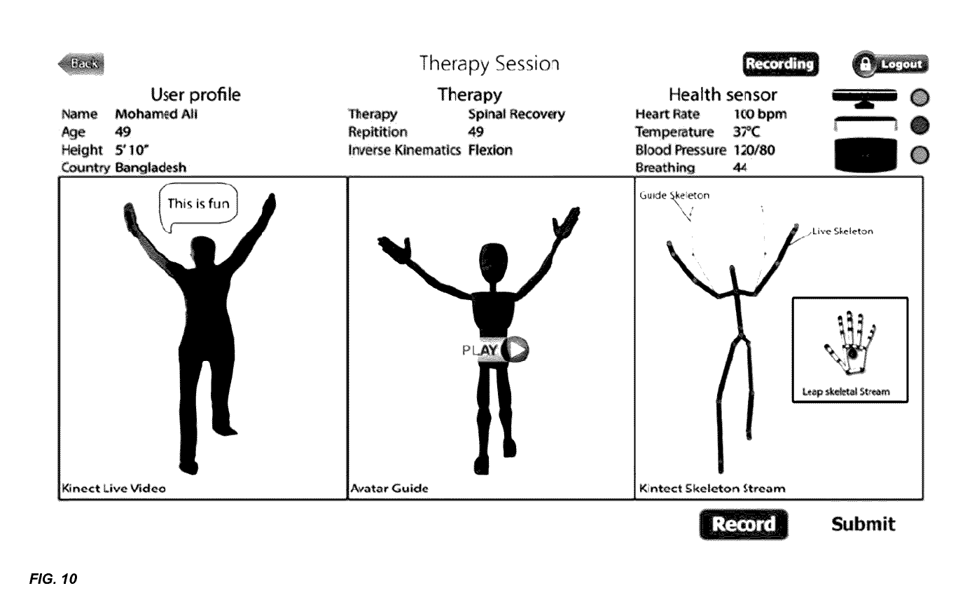

Embodiments of this feature of the multimedia system of this disclosure are illustrated in FIGS. 8 to 10.

Although the present embodiments have been described with reference to specific example embodiments, it will be evident that various modifications and changes may be made to these embodiments without departing from the broader spirit and scope of the various embodiments.

The specification and drawings are to be regarded in an illustrative rather than a restrictive sense.

### INDUSTRIAL APPLICABILITY

This disclosure relates to a multimedia system that synchronizes data such as audio and video data with skeletal data of a patient. The system allows for interaction between a therapist and a patient performing therapeutic activities at home. The system is practical and efficient for use in at-home therapy and would allow for substantive savings in healthcare costs while providing clinical level of data accuracy regarding the improvement of therapies to the therapist.

What is claimed is:

1. A method, comprising:
creating a media stream comprising audio and video data;
creating a model skeletal data stream;
synchronizing the media stream with the model skeletal data stream to create a synchronized multimedia stream; and
storing the synchronized multimedia stream in a big data repository,
wherein a user accesses the repository and performs physical activities based on the model skeletal data stream and records the physical activities, and wherein the user or at least one other user accesses the repository, evaluates the recorded physical activities and makes multimedia notes on the media stream, the notes being stored in a metadata file.

2. The method of claim 1, further comprising synchronizing the multimedia notes with the synchronized multimedia stream and storing the synchronized multimedia stream and notes in the data repository.

3. The method of claim 1, wherein the notes are in a form selected from the group consisting of audio notes, video notes and text notes.

4. The method of claim 1, wherein the data repository further comprises data selected from the group consisting of statistical data, graphical data, summary of the physical activities for the user, historical data on the physical activities of the user, personal information of the user including name, date of birth, and banking information.

5. The method of claim 1, wherein the user or the at least one other user provides confidential identification codes prior to accessing the data repository.

6. The method of claim 1, wherein the user or the at least one other user performs a search in the metadata file.

7. The method of claim 1, wherein the user or the at least one other user makes queries from a query vocabulary database.

8. The method of claim 1, wherein the user reviews notes made by the at least other user and further performs and records revised physical activities based on the notes.

9. The method of claim 1, wherein the user or the at least one other user performs a business transaction including payment of a fee.

10. The method of claim 1, wherein the user is a patient, the at least one other user is a therapist, and the physical activities are therapeutic physical activities.

11. The method of claim 1, wherein the model skeletal data stream comprises a model therapy Avatar in the form of skeletal figure, an Avatar within a game environment or a skeleton projected on the raw video in an augmented reality environment.

12. A multimedia system, comprising:
a synchronized multimedia stream comprising a media stream including audio and video data, and a model skeletal data stream, the synchronized multimedia stream being stored in a data repository;
a recorder for recording physical activities performed by a user based on the model skeletal data stream; and
a player for outputting the recorded physical activities and for allowing production, by the user or the at least one other user, of multimedia notes on the media stream, the notes being stored in a metadata file.

13. The system of claim 12, wherein the recorder comprises at least one sensor selected from the group consisting of Kinect, LEAP, MYO and health sensors including heart rate monitor and pulse oximeter.

14. The system of claim 12, wherein the recorder comprises a gesture parser.

15. The system of claim 12, further comprising a query analytics engine for performing searches in the metadata file.
